(19) United States
(12) Patent Application Publication
(10) Pub. No.: US 2004/0074406 A1
(43) Pub. Date: Apr. 22, 2004

(54) Drive mechanish of a printing unit

(76) Inventors: Erich Max Karl Gerner, Butthard (DE); Bernd Kurt Masuch, Kurnach (DE); Kurt Johannes Weschenfelder, Zell/Main (DE)

Correspondence Address: Douglas R. Hanscom, Jones, Tullar & Cooper, PO Box 2266 Eads Station, Arlington, VA, 22202, US

(21) Appl. No.: 10/466,111

(22) PCT Filed: Feb. 5, 2002
(86) PCT No.: PCT/DE02/00413

(30) Foreign Application Priority Data
Mar. 26, 2001 (DE) 101 14 806.2
Nov. 8, 2001 (DE) 101 54 837.0

(51) Int. Cl. B41F 5/00

(52) U.S. Cl. 101/216

(57) ABSTRACT

A drive mechanism is provided for a printing unit which is comprised of a first cylinder having its own drive motor, and a second cylinder that cooperates with the first cylinder in a printing position and which has its own drive motor. A standard locking gear, which has at least one pair of links which are cooperating with one another and with spur toothing, is arranged between the first cylinder and its assigned drive motor.

The invention relates to a drive mechanism for a printing unit in accordance with the preamble of claim 1.

A printing unit with forme, transfer and counter-pressure cylinders is known from JP 56-021860 A, wherein each one of the three cylinders is driven by means of its own drive motor.

DE 196 03 663 A1 shows a bridge printing unit with printing unit cylinders, each of which is driven by its own drive motor. Each of the forme cylinders is driven via a drive pinion gear assigned to the drive motor, the transfer cylinders via coaxially arranged stators and cylinder journals embodied as rotors.

Individually driven forme, transfer and counter-pressure cylinders, each with its own drive motor, are disclosed in EP 0 699 524 A2, wherein extensions of the cylinder journals which are embodied as rotors work together with stators.

A drive for a pair of cylinders is disclosed in DE 34 09 194 A1, wherein a pinion gear with straight-toothed wheels of a drive motor drives a gear wheel with straight-toothed wheels of a transfer cylinder, wherein the latter drives a forme cylinder via a helical gear.

A drive mechanism for a printing unit is known from DE 197 55 316 C2, wherein two cooperating cylinders each have a drive motor and a gear arranged between the drive motor and the respective cylinder.

The object of the invention is based on creating a drive mechanism for a printing unit.

In accordance with the invention, this object is attained by means of the characteristics of claim 1.

The advantages which can be gained by means of the invention lie in particular in that the drive mechanism assures great flexibility during operations, but yet is designed as cost-effectively as possible and can be standardized.

The drive motors can therefore be laid out lower, and therefore more cost-effectively, and under certain conditions for identical output requirements and/or identical operational numbers of revolutions.

The arrangement and the dimensions of gears between all cylinders and the drive motors is particularly advantageous in view of maintaining the optimum range of numbers of revolutions for the drive motors. In particular for various different operating conditions, such as occur, for example, during set-up and subsequent acceleration, as well as stationary operation in the course of printing, a reduction between the rotation of the motor shaft and the cylinder of, for example, 2:1 to 10:1, in particular between 2:1 and 5:1 is of particular advantage (in connection with the number of revolutions of cylinders of twice the circumference of 500 to 850 per minute, for cylinders of single circumference of 1,000 to 1,700 revolutions per minute). The motors run in a preferred range between 1,000 to 3,000 rpm, in particular between 1,500 to 2,500 rpm. The mentioned ranges are values for operation during production. These can of course be considerably lower for setting-up.

The use of reduction gears embodied as planetary gears is useful in a particularly advantageous embodiment in view of compact structural space and a large range of gear ratios to be realized.

It is provided in an also advantageous embodiment to encapsulate each gear separately. This can take place in a manner where they are structurally separated from the drive motor, but also in such a way that the drive motor and the gear are combined into one component.

In a further development of the invention, the gear of a cylinder which is to be moved axially for adjusting the side register is designed in such a way that the axial movement has no effect on the circumferential register which, as a rule, is the case with a helical gear. A coupling, whose length can be changed axially, or electronic readjustment of the circumferential register, are also not required.

By employing gears with normal planar contact, a pivot movement, for example for the purpose of contacting or of releasing contact, is possible, even though only to a limited extent, without having to move the drive motor or without displacing the shafts of a rotor and of a stator fixed to the frame in respect to each other. Because of its own drive motor, the drive mechanism of each individual cylinder makes possible the most diverse set-up and maintenance work on the cylinders independently of each other to a large degree, or of a web of material to be imprinted which might have been drawn in.

The embodiment of the gear which can be axially displaced is advantageous, in particular in connection with the individual encapsulation and the individually driven cylinders, since for one an oil chamber extending over several components is avoided, and it is furthermore possible to save considerable structural space.

Exemplary embodiments of the invention are represented in the drawings and will be described in detail in what follows.

Shown are in:

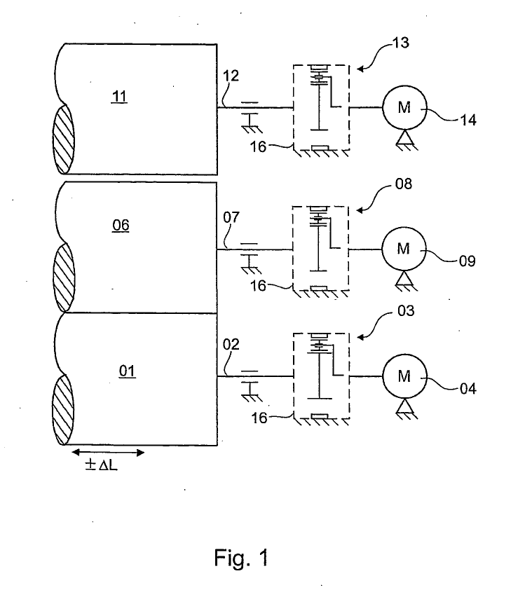

FIG. 1, a first exemplary embodiment of a drive mechanism for a printing unit using epicyclic gears (symbolically represented),

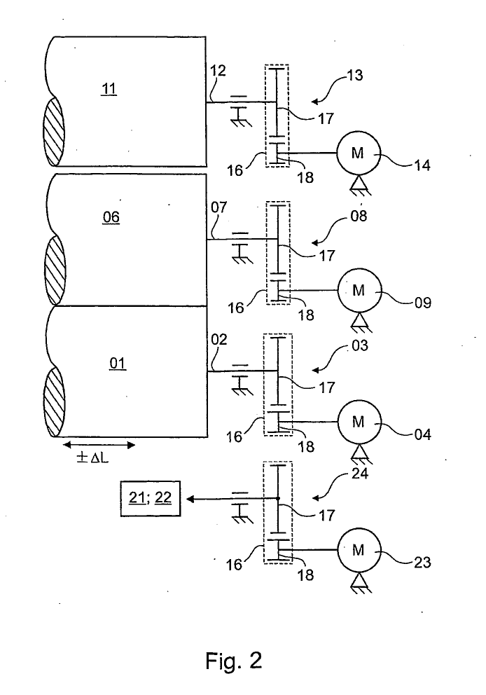

FIG. 2, a second exemplary embodiment of a drive mechanism for a printing unit using fixed gears with external teeth,

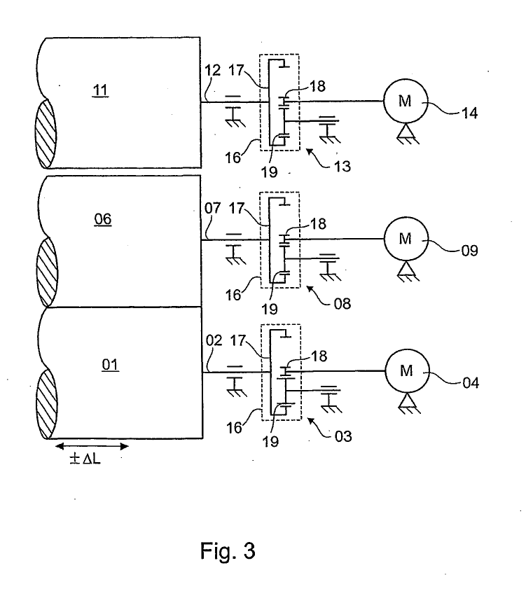

FIG. 3, a third exemplary embodiment of the drive of a printing unit using fixed gears with internal teeth.

A printing unit of a printing press, in particular of a rotary printing press, has a first cylinder 01, for example a forme cylinder 01, which has on at least one front face a journal 02, which is rotatably seated in a frame, not represented. On its front end, the forme cylinder is in operative connection with a drive motor 04 via a gear 03 for being rotationally driven.

In a print-on position, the forme cylinder 01 works together with a second cylinder 06, which also has on at least one front face a journal 07, which is rotatably seated in a frame. The second cylinder 06 is also in operative connection with a drive motor 09 via a gear 08 for being rotationally driven.

For direct printing methods, the second cylinder 06 can be a counter-pressure cylinder 06, wherein an unidentified printing location is formed between the forme and counter-pressure cylinders 01, 06. In the exemplary embodiment (FIG. 1), the second cylinder is embodied as an ink-conveying transfer cylinder 06, for example as a rubber blanket cylinder.

The two cylinders 01, 06 are not in a positive drive connection and are driven independently of each other by respective drive motors 04, 05 via the respective gear 03, 08.

In a print-on position the transfer cylinder 06 works together via a web to be imprinted, not represented, for example a paper web, with a third cylinder 11, which is also rotatably seated in the frame on at least one of its front faces, for example by means of a journal 12. The third cylinder 11 is used as a counter-pressure cylinder 06 for the transfer cylinder 06 and, in case of a double printing unit for simultaneous sheet work under the “rubber-against-rubber” principle, can be embodied as a further transfer cylinder 11, which acts together with a further forme cylinder, not represented. In the exemplary embodiment (FIG. 1) the third cylinder is embodied as a cylinder 11 not conveying any ink, for example as a satellite cylinder 11, which on its circumference works together with further cylinder pairs corresponding to the cylinder pair 01, 06.

The third cylinder 11 can be driven without a mechanical drive connection (with the exception of the friction wheel drive formed by the cylinders 06, 11, which roll off on each other) to the first two cylinders 01, 06.

In an advantageous embodiment, the third cylinder 11 is also in operative connection with its own drive motor 14 via a gear 13 for being rotationally driven. In an advantageous further development of the invention, at least the forme cylinder 01 is embodied to be movable by an amount Delta L, preferably in both directions around a zero position, for adjusting the side register along its axial direction. This amount Delta L preferably lies between 0 and ±4 mm, in particular between 0 and ±2.5 mm. This takes place by means of a drive mechanism, not represented, which is preferably arranged on the side of the cylinder 01 opposite the rotational drive mechanism.

The gears 03, 08, 13 each have at least one pair of positively cooperating members with normal planar contact, which in principle can be realized in different ways, for example as traction mechanism gears or wheel gears. Advantageous embodiments will be described by means of the subsequent exemplary embodiments (FIGS. 1 to 3).

In a first exemplary embodiment (FIG. 1), the gears 03, 08, 13 are embodied as gears 03, 08, 13 with coaxial axis positions, for example as epicyclic gears, such as planetary gears 03, 08, 13 in particular (not shown in detail, but only symbolically in FIG. 1). The axes of the gears 03, 08, 13 and the shafts of the drive motors 04, 09, 14 are each arranged coaxially in respect to the axes of rotation of the cylinders 01. 06, 11. The compact construction by means of gears 03, 08, 13 with coaxial axis positions, in particular of the planetary gears 03, 08, 13 makes possible an arrangement which saves a great amount of structural space. The extensive range of possible step-up or reduction gear relations in connection with such gears 03, 08, 13 makes possible the use of drive motors 04, 09, 14 of low drive output, while simultaneously assuring optimal ranges of the number of revolutions. In connection with the respectively individually driven cylinders 01, 06, 11, drive motors 04, 09, 14 with identical drive outputs can be used.

The planetary gears 03, 08, 13 can also form a component together with the drive motors 04, 09, 14, and can be directly connected with them.

In an advantageous embodiment, each gear 03, 09, 13 is encapsulated by means of a cover 16 (indicated by dashed lines in the figures), so that neither dirt can penetrate into the interior, nor can a lubricant possibly contained in the interior, in particular a thin-bodied lubricant, for example oil, escape to the outside from the lubricant chamber formed in this way. The individual encapsulation provides great advantages in regard to maintenance, an exchange of individual components and the compact construction of the drive system. In connection with the straight-toothed wheels in particular, which are embodied to be axially movable in respect to each other, the encapsulation and the lubricant make possible the low-friction movement of the gear tooth connection and simultaneously little wear in the course of axial movements.

In the second exemplary embodiment (FIG. 2) the gears 03, 08, 13 are embodied as gears 03, 08, 13 with their shafts in a parallel position, in particular as wheel gears 03, 08, 13 with fixed shafts. A gear wheel 17, which is seated, fixed against relative rotation, at the journal 02, 07, 12 of the respective cylinders 01, 06, 11, meshes with a second gear wheel 18, for example a pinion 18, which is connected, fixed against relative rotation, with a shaft of the drive motor 04, 09, 14. The gear 03, 08, 13 can also have a large chain wheel or other gear elements of different types. In the case of the gear wheels 17, 18 assigned to the transfer and the counter-pressure cylinders 06, 11 in particular, these gear wheels 17, 18 can be embodied with helical teeth for increased stability under stress. The gear wheels 17, 18 at the forme cylinder 01 can also be embodied with helical teeth for the case in which, for adjusting the side register, the gear 03 and the drive motor 04 of the forme cylinder 01 must also be moved, in addition to the forme cylinder 01 itself, or when, in the case of the drive motor 04, fixed in place on the frame, and the pinion 18, steps are taken for correcting the circumferential register when the side register is adjusted.

In a variation not represented, the gears 03, 08, 13 in accordance with the second exemplary embodiment can also be embodied in the form of a positive belt drive, or can have such a one.

In a third exemplary embodiment (FIG. 3), the gears 03, 08, 13 are embodied, the same as in the second exemplary embodiment, as wheel gears 03, 08, 13 with fixed shafts, but with internal teeth on the gear wheel 17 connected with the cylinder 01, 06, 11. One or several gear wheels 19, comparable to the planetary wheels of a planetary gear, but having a rotary shaft fixed in place on the frame, can be arranged between this gear wheel 17 and the pinion 18 of the drive motor 04, 09, 14. The gear 03, 08, 13 can be designed as a gear 03, 08, 13 with a coaxial shaft position in spite of the possibility of a large gear reduction.

In a variation of the third exemplary embodiment, the third gear wheel 19 can be omitted, wherein in this case the shafts of the drive motor 08, 09, 14 and of the respective cylinders 01, 06, 11 can extend parallel and not coaxially.

Particularly advantageous for all of the above mentioned exemplary embodiments is an arrangement, wherein the drive motors 04, 09, 11, as well as the portion of the gear 03, 08, 13 assigned to the drive motors 04, 09, 11 and of the gear housing, or the cover 16, are fixed in place on the frame.

In the exemplary embodiments, at least one pair of cooperating members of the gear 03 assigned to the forme cylinder 01 is embodied in an advantageous way with straight teeth and allows a relative movement in the axial direction between the two members in respect to each other. In the first exemplary embodiment (FIG. 1) such a pair of members can be a sun wheel, not identified in FIG. 1, and one or several planetary wheels, in the second exemplary embodiment (FIG. 2) it can be the pinion 18 and the gear wheel 17, and in the third exemplary embodiment it can be the gear wheel 19 and one of the gear wheels 17 or 18.

The members of the gear 03 assigned to the forme cylinder 01, which can be moved in relation to each other in respect to an axial movement, are dimensioned in such a way that in none of the positions of the forme cylinder 01 permitted for operation the maximum stress on the positive connection of the members which can be moved toward each other, for example the teeth, is exceeded in respect to wear and freedom from breakage.

As indicated in FIGS. 1 to 3, for example, for this purpose at least one of the gear teeth in the planetary gear 03, 08, 13, at least one of the gear wheels 17, 18 of the wheel gear 03, 08, 13 in the second exemplary embodiment, or at least one of the gear wheels 17, 18, or possibly 19, of the wheel gear 03, 08, 13 in the third exemplary embodiment, is embodied widened in the axial direction. The width has been selected to be such that with an axial displacement of the forme cylinder 01 by an amount Delta L, sufficient coverage of the gear teeth is assured. Thus, the forme cylinder 01 can also be axially moved without it being necessary to also move the drive motor 04, 09, 14 and a housing of the gear 03.

For the assembly and maintenance of the drive motor 04, 09, 14 it is possible to provide a coupling (not represented), which is not switchable, but removable, between the drive motor 04, 09, 14 and the gear 03, 08, 13, with the exception of the exemplary embodiment in which the drive motor 04, 09, 14 and the gear 03, 08, 13 form a connected component. In the arrangement of such components 03, 04, 08, 09, 13, 14 it is advantageous to provide a coupling (not represented), which is not switchable, but removable, between the gear 03, 08, 13 and the cylinders 01, 06, 11.

A further development of the invention is of particular advantage, wherein a coupling which compensates angular changes and/or offset, for example a double joint or a coupling having two spring assemblies and a bar, is arranged between the transfer cylinder 06 and the assigned gear 08. Thus pivoting of the transfer cylinder 06 is possible in spite of the fixed arrangement on the frame of the gear 08 and the drive motor 09.

In a further development it is possible to drive one or several rollers of an inking unit 21, as well as possibly a dampening unit 22 assigned to the forme cylinder 01, by friction by means of one of the cylinders 01, 06, 11, in particular the forme cylinder 01. This can take place, for example, via a gear train, for example a not represented gear wheel which is connected with the forme cylinder 01.

In respect to a drive of the printing unit which is as free as possible of malfunctions and reactive coupling, however, it is advantageous if the roller, or rollers, of the inking unit 21, which is only schematically indicated, is/are driven by a further drive motor 23 via a gear 24. This is represented by way of example in FIG. 2 also for the other exemplary embodiments. Here, too, the single encapsulation is of great advantage in view of accessibility and soiling of the printing press. The same applies to a possibly provided dampening unit 22. However, if desired, the rollers or cylinders of the inking and dampening units can also be driven together by one drive motor.

If a friction cylinder is driven by the drive motor 23 via the gear 24, this should advantageously take place in the same way as with the forme cylinder 01, so that the axial shifting motion remains without effect on the position in the circumferential direction.

List of Reference Symbols

| | |
|---|---|
| 01 | Cylinder, first, forme cylinder |
| 02 | Journal (01) |
| 03 | Gear, planetary gear, wheel gear (01) |
| 04 | Drive motor (01) |
| 05 | — |
| 06 | Cylinder, second, counter-pressure cylinder, transfer |
| | cylinder, satellite cylinder |
| 07 | Journal (06) |
| 08 | Gear, planetary gear, wheel gear (06) |
| 09 | Drive motor (06) |
| 10 | — |
| 11 | Cylinder, third, counter-pressure cylinder, transfer |
| | cylinder, satellite cylinder |
| 12 | Journal (11) |
| 13 | Gear, planetary gear, wheel gear (11) |
| 14 | Drive motor (11) |
| 15 | — |
| 16 | Cover (03, 08, 13) |
| 17 | Gear wheel (03, 08, 13) |
| 18 | Gear wheel, pinion (03, 08, 13) |
| 19 | Gear wheel (03, 08, 13) |

Delta L Amount of an axial movement (01)

1. A drive mechanism of a printing unit, having at least one first cylinder (01) designed as a forme cylinder, and having a second cylinder (06), which operates together with the forme cylinder (01) in a print-on position, wherein the two cylinders (01, 06) can each be driven by their own drive motor (04, 09), and wherein a gear (03, 08) is arranged between each of the cylinders (01, 02) and the respective drive motor (04, 09), characterized in that at least one cooperating pair of the gear (03) assigned to the forme cylinder (01) is embodied with straight teeth and can be moved in relation to each other.

2. The drive mechanism in accordance with claim 1, characterized in that the second cylinder (06) is embodied as a transfer cylinder (06).

3. The drive mechanism in accordance with claim 1, characterized in that the second cylinder (06) is embodied as a counter-pressure cylinder (06).

4. The drive mechanism in accordance with claim 2, characterized in that in a print-on position, the transfer cylinder (06) cooperates with a third cylinder (11), which has no positively-connected drive connection with the drive motors (04, 09) of the two first cylinders (01, 06).

5. The drive mechanism in accordance with claim 4, characterized in that the third cylinder (11) has its own drive motor (14).

6. The drive mechanism in accordance with claim 5, that a gear (13) is arranged between the third cylinder (11) and its drive motor (14).

7. The drive mechanism in accordance with claim 1 or 6, characterized in that the gear (03, 08, 13) is designed as a gear (03, 08, 13) which reduces the number of revolutions of a shaft of the drive motor (04, 09, 14) toward the number of revolutions of the cylinder (01, 06, 11).

8. The drive mechanism in accordance with claim 1 or 6, characterized in that the gear (03, 08, 13) is designed as a wheel gear (03, 08, 13).

9. The drive mechanism in accordance with claim 8, characterized in that the gear (03, 08, 13) is designed as a gear (03, 08, 13) with coaxial shaft positions.

10. The drive mechanism in accordance with claim 8, characterized in that the gear (03, 08, 13) is designed as a gear (03, 08, 13) with parallel and spaced-apart shaft positions.

11. The drive mechanism in accordance with claim 9, characterized in that the gear (03, 08, 13) is designed as a planetary gear (03, 08, 13).

12. The drive mechanism in accordance with claim 9 or 10, characterized in that the gear (03, 08, 13) has at least one gear wheel (17) which is connected, fixed against relative rotation, with the cylinder (01, 06, 11).

13. The drive mechanism in accordance with claim 12, characterized in that the gear wheel (17) is provided with internal teeth.

14. The drive mechanism in accordance with claim 12, characterized in that the gear wheel (17) is provided with external teeth.

15. The drive mechanism in accordance with claim 1 or 6, characterized in that the gear (03, 08, 13) is embodied to be individually encapsulated.

16. The drive mechanism in accordance with claim 15, characterized in that the individually encapsulated gear (03, 08, 13) only contains lubricant in the interior of the encapsulation formed by a cover (16).

17. The drive mechanism in accordance with claim 1 and 16, characterized in that each of the gears (03, 08, 13) has its own encapsulated lubricant chamber.

18. The drive mechanism in accordance with claim 2 or 3, characterized in that at least the forme cylinder (01) is embodied to be axially movable by an amount (Delta L).

19. The drive mechanism in accordance with claim 1 or 6, characterized in that the drive motor (04, 09, 14), as well as a portion of the gear (03, 08, 13) assigned to the drive motor (04, 09, 14), are embodied fixed to the frame.

20. The drive mechanism in accordance with claim 1, characterized in that the gear (03) assigned to the forme cylinder (01) absorbs an axially relative movement between the forme cylinder (01) and the drive motor (04).

21. The drive mechanism in accordance with claim 1, characterized in that the straight-toothed cooperating members of the gear (03) assigned to the forme cylinder (01) are dimensioned in such a way that the maximum stress on the positive connection of the members which can be moved in relation to each other is not exceeded in any of the axial positions of the forme cylinder (01).

22. The drive mechanism in accordance with claim 4, characterized in that the gear (08, 13) at the second cylinder (06) embodied as a transfer cylinder (06), and on the third cylinder (11) embodied as a counter-pressure cylinder (11), is arranged fixed to the frame.

23. The drive mechanism in accordance with claim 1, characterized in that an inking unit (21) with at least one roller is assigned to the forme cylinder (01), and is rotationally driven via a gear (24) by a drive motor (23), which is independent of the drive mechanism of the forme cylinder (01).
